(19) United States
(12) Patent Application Publication
(10) Pub. No.: US 2026/0139895 A1
(43) Pub. Date: May 21, 2026

(54) STORAGE AND RETRIEVAL SYSTEM

(71) Applicant: Ocado Innovation Limited, Hatfield (GB)

(72) Inventor: Leslie WYNN, Hatfield (GB)

(21) Appl. No.: 19/452,961

(22) Filed: Jan. 20, 2026

Related U.S. Application Data
(63) Continuation of application No. PCT/EP2024/070552, filed on Jul. 19, 2024.

(30) Foreign Application Priority Data
Jul. 21, 2023 (GB) 2311209.7

(51) Int. Cl. F25D 25/00; B65G 1/04; F25D 17/04

(52) U.S. Cl. CPC F25D 25/005; B65G 1/0464; F25D 17/045

(57) ABSTRACT

A storage and retrieval system comprising an enclosure in which the air temperature is regulated. The enclosure houses a storage structure comprising a track system arranged in a grid pattern, a plurality of storage columns for storing stacks of storage containers and a plurality or port columns, including a drop-off column and a pick-up column. A portion of the enclosure houses an access station for accessing the contents of a storage container. The access station is located below the track structure and between the drop-off column and the pick-up column to define a passage between the drop-off column and the pick-up column. The access station comprises a conveying device configured to convey a storage container along the passage. The portion of the enclosure comprises an external opening for allowing access to a storage container at the access station from outside the enclosure.

### RELATED APPLICATIONS

This application is a continuation of international patent application No. PCT/EP 2024/070552, entitled “Storage and Retrieval System”, filed 19 Jul. 2024, which claims priority to UK patent application No. GB2311209.7, entitled “Storage and Retrieval System”, filed 21 Jul. 2023; the entire contents of all of which applications are incorporated herein by reference.

### TECHNICAL FIELD

The present invention relates to storage and retrieval systems comprising robotic load handling devices that operate on a storage structure for handling storage containers stacked in the storage structure.

### BACKGROUND

Some commercial and industrial activities require systems that enable the storage and retrieval of a large number of different products. WO2015019055A1 describes a storage and retrieval system in which items are stored in storage containers and the storage containers are arranged in stacks within a storage structure. The system further comprises remotely operated load handling devices configured to move on tracks located on the top of the storage structure. To pick up or drop off storage containers stored in the storage structure, each load handling device is equipped with a gripper device for releasably holding a storage container, and a lifting assembly for raising and lowering the gripper device. To fulfil customer orders, storage containers containing the ordered products are picked up from the storage structure and dropped off at a picking station where the ordered products are taken out of the storage containers and placed into delivery containers. The storage containers are then picked up from the picking station and returned to storage in the storage structure. The picking stations are typically located below or immediately adjacent to a portion of the storage structure such that storage containers can be moved efficiently between the storage structure and the picking stations.

Within the context of a grocery selling business, it is desirable to automate the storage and retrieval of a wide range of food items. While the above storage and retrieval system has been commonly deployed for the storage and retrieval of ambient food items and chilled food items, there are challenges associated with the automated storage and retrieval of frozen food items, which require lower temperatures than ambient and chilled goods for safe storage, typically 18° C. or lower. In the case where picking stations are manned by human workers, each worker would typically be required to wear a significant level of personal protective equipment (PPE) and/or work in very short shifts to mitigate the effects of working at freezing temperatures.

It is therefore desirable to provide a storage and retrieval system for storing and retrieving frozen grocery goods that allows for a more comfortable and safer environment for human workers to work in.

### SUMMARY OF THE INVENTION

Embodiments of the invention are defined in the accompanying claims.

One or more aspects and embodiments of the present invention provide a storage and retrieval system comprising: an enclosure comprising a temperature control system configured to regulate the air temperature inside the enclosure, wherein the enclosure houses:
a storage structure comprising:
   a supporting framework structure comprising a plurality of storage columns, each of the plurality of storage columns being arranged to accommodate a stack of storage containers;
   a track structure comprising a plurality of tracks arranged to form a grid pattern defining a plurality of grid cells, said track structure is mounted on the supporting framework structure such that each stack of storage containers is arranged below a grid cell; and
   a plurality of port columns comprising a drop-off column for dropping-off a storage container from the track structure and a pick-up column for picking up a storage container from the track structure;
wherein a portion of the enclosure houses an access station located below the track structure, wherein the access station is connected between the drop-off column and the pick-up column to define a passage between the drop-off column and the pick-up column, the access station comprising a conveying device configured to convey a storage container along the passage; and
wherein the portion of the enclosure comprises an external opening for allowing access to a storage container at the access station from outside the enclosure.

In example storage and retrieval systems according to the present invention, a storage container can thus be retrieved from the storage structure, have goods moved into and/or out of the storage container at the portion of the enclosure housing the access station and be returned back to the storage structure, without leaving the temperature-regulated enclosure. In other words, the storage containers can remain in the enclosure at all times while still being accessible from outside the enclosure at the portion of the enclosure housing the access station. This may be advantageous for the storage and retrieval of temperature-sensitive goods, such as grocery items. The present storage and retrieval system may be particularly advantageous for the storage and retrieval of frozen grocery items, which are typically stored at a temperature of, e.g., −18° C. (0° F.) or lower for food safety reasons. By allowing a storage container to stay within the enclosure at all times, the outside of the enclosure can be warmer than the temperature inside the enclosure to provide a more comfortable environment for human workers to work in.

The enclosure houses an access station, or more specifically, a portion of the enclosure houses an access station. The portion of the enclosure surrounds the access station such that the access station is kept at the regulated air temperature of the enclosure. The portion of the enclosure comprises an external opening. The external opening allows access from outside the enclosure to a storage container being conveyed along the passage from the drop-off column to the pick-up column.

Optionally, the enclosure may be arranged to define a channel. Preferably, the access station is positioned at least partially within the channel. The channel may extend beneath the track structure and/or the channel may be located beneath an area devoid of storage columns. The channel may extend from a first side of the storage structure to an opposing second side of the storage structure. Alternatively, the channel may extend from a first side of the storage structure to a substantially central position in the storage structure, such that the channel ends under a central portion of the track structure. Storage columns may be located on either side of the access station and thus, the storage structure may be divided into a first zone of storage columns and a second zone of storage columns by the channel. The access station and the track system may therefore allow movement of storage containers from the first zone of storage columns to the second zone of storage columns and vice versa. The first zone and the second zone may store containers comprising items for picking. Alternatively, the first zone may comprise storage containers comprising items for picking, while the containers stored in the second zone may be delivery containers which contain one or more items according to a customer's order.

Alternatively, the access station may be located on a side or face or periphery of the storage structure. The plurality of port columns may also be located on the periphery of the storage structure. By locating the access station on the periphery of the storage structure, a channel is not required and therefore the footprint of the storage and retrieval system may be reduced.

The temperature control system may comprise a refrigeration system configured to maintain a first air temperature inside the enclosure. The first air temperature may be a temperature suitable for storing chilled goods, which is in the temperature range of 1° C. to 4° C. The first air temperature may be a temperature suitable for storing frozen grocery items, which is typically in the region of −25° C. to −18° C. The first air temperature may be at a temperature at or below 0° C. The first air temperature may be at or below −18° C.

The temperature control system may comprise a heating or refrigeration system configured to maintain a second air temperature outside the enclosure. The second air temperature may be higher than the first air temperature. The system may further comprise a second temperature control system, said second temperature control system comprising a heating or refrigeration system configured to maintain an environment externally of the enclosure having a second air temperature greater than the first air temperature. The second air temperature can therefore be maintained at a temperature which is comfortable for personnel picking chilled or frozen items from storage containers at the access station.

Optionally, the system further comprises a chamber surrounding the access station, said second temperature control system being configured to maintain the environment within the chamber at the second air temperature. Specifically, the chamber may be positioned at least partially within the channel such that the chamber occupies at least a portion of the channel. The temperature control system may comprise a heating or refrigeration system configured to maintain a second air temperature inside the chamber. The chamber air temperature may be higher than the first air temperature. The chamber may comprise a plurality of walls. One or more walls may be formed from or comprise a thermally insulating material. For example, the one or more walls may comprise one or more of polystyrene foam, mineral wool, polyurethane foam, fibreglass, aerogel or cellulose. Thus, personnel may work within the chamber at a second air temperature. Since the chamber may have a smaller volume than the volume outside the enclosure, it is more energy efficient to maintain the environment within the chamber at the second air temperature than maintaining the second air temperature outside the enclosure.

The second air temperature outside the enclosure or inside the chamber may be between −10° C. and 10° C. The second air temperature may be between 0° C. and 10° C. Preferably, the second air temperature may be between 0° C. and 5° C.

The enclosure may comprise a plurality of walls. One or more walls may be formed from or comprise a thermally insulating material. For example, the plurality of walls may comprise one or more of polystyrene foam, mineral wool, polyurethane foam, fibreglass, aerogel or cellulose. Having thermally insulating walls helps to maintain the first temperature within the enclosure and improves energy efficiency.

The portion of the enclosure may comprise a barrier configured to selectively open and close the external opening. The barrier may be solid. For example, the barrier may be a hinged or slidable door, e.g., a thermally insulated door. The portion of the enclosure may comprise a rotary or linear actuator configured to move the barrier to selectively open and close the external opening. The barrier may be transparent to allow a human picker to see when a storage container has arrived at the external opening. The storage and retrieval system may comprise a control system configured to control the actuator to open the barrier when a storage container is at the external opening and close the barrier when a storage container is not present at the external opening. Alternatively or in addition to the barrier, the portion of the enclosure may comprise an air curtain configured to produce a stream of air across the external opening. The stream of air acts as an air barrier or air seal which minimises air flow through the external opening while still allowing goods to be passed through the external opening relatively unimpeded. Thus, the air curtain separates and helps maintain the different temperatures inside and outside the enclosure while allowing unobstructed vision through the external opening.

Optionally, the external opening may be located on a top-facing side of the portion of the enclosure. In this context, ‘top-facing side’ means (refers to) the uppermost surface. Having the external opening on the top-facing side of the portion of the enclosure allows an item picker to see down into the storage containers and see items stored within each storage container as the storage containers are conveyed along the passage.

Optionally, the portion of the enclosure housing the access station comprises a tunnel or passageway. The tunnel may extend between the drop-off column and the pick-up column such that the access station is fully enclosed within the tunnel. The tunnel may comprise the external opening for allowing access to a storage container at the access station from outside the enclosure. The tunnel may comprise a barrier for configured to selectively open and close the external opening. Alternatively, or in addition, the tunnel may comprise an air curtain configured to produce a stream of air across the external opening. Preferably, the external opening is located on a top-facing side of the tunnel.

The access station may comprise a first access station and a second access station, and wherein the external opening may comprise a first external opening and a second external opening such that the first external opening provides access to the first access station through the portion of the enclosure and the second external opening provides access to the second access station through the portion of the enclosure. Optionally, the plurality of port columns may comprise a plurality of drop-off columns and a plurality of pick-up columns and the passage of the first access station and the second access station is connected between a respective drop-off column and a respective pick-up column. Having multiple drop-off columns, pick-up columns and a first and second access station reduces congestion around the port columns, thereby increasing the time that containers can be picked from stacks of containers in the storage structure, thereby increasing the speed at which customer orders can be gathered. Further, by having a first and second access station, items from the containers may be picked faster either by one or multiple human or robotic item pickers, thereby increasing the speed at which customer orders can be compiled.

Optionally, the first access station is below the second access station. Thus, the first external opening providing access to the first access station may be below the second external opening providing access to the second access station. In this configuration, the first access station may be used for picking inventory items out of storage containers and the second access station may be used for presenting delivery containers into which the picked inventory items are placed, or vice versa. Having external openings at different heights may provide ergonomic benefits to a human worker.

The first access station may be located adjacent to a second access station. The passage of the first access station may extend parallel to the passage of the second access station. The first and second access stations may be stacked one on top of the other, or the first and second access stations may be located side-by-side. If the first access station and the second access station are stacked one on top of the other, preferably there is a gap between the first and second access stations. The gap allows the item picker space to pick items from a storage container or place items into a delivery container through the external opening providing access to the lower access station. Both the first access station and the second access station may be used to pick inventory items out of storage containers, such that if the first and second access stations are stacked one on top of the other, a single item picker may pick items from the containers at the first and second access stations. Alternatively, the first access station may be used to pick inventory items out of storage containers and the second access station may be used to present delivery containers into which the picked inventory items are placed, such that if the first and second access stations are stacked one on top of the other, a single item picker may pick items from the first access station and place the items through the higher or lower external opening providing access to the second access station, or vice versa. If the first and second access stations are located side-by-side, a single item picker may pick from containers at both the first access station and the second access station, or may pick from storage containers at the first access station and place the picked items into delivery containers at the second access station.

The passage of the first access station may extend under the passage of the second access station in a direction perpendicular to the passage of the second access station. This arrangement provides ergonomic benefits to a human worker when moving items from the first access station to the second access station or vice versa as the worker does not need to reach over a portion of the enclosure housing one of the access stations to access the external opening providing access to the other access station.

The storage and retrieval system may further comprise a fan system configured to generate a positive pressure within the enclosure. The fan system may also be termed a ‘positive input ventilator (a.k.a., PIV)’. The fan may draw fresh air from outside the enclosure and push the fresh air into the enclosure. The air pressure within the enclosure thus increases. If the humidity of the air in the enclosure is high enough and the air temperature of the enclosure is suitable for the storage of freezer goods, there is a risk of condensation occurring in the enclosure which could result in undesirable formation of frost or ice on the walls and equipment in the enclosure. The fan system advantageously reduces condensation within the closure by forcing out any moisture in the air through natural leakage gaps in the walls of the enclosure.

The storage and retrieval system may further comprise a dehumidifier system configured to draw air from outside the enclosure, dehumidify the drawn air, and discharge the dehumidified air into the enclosure. In this context, the term ‘dehumidify’ means to remove moisture from the air. The dehumidifier system, may comprise ducting configured to direct air from one or more inlets from outside the enclosure to one or more outlets in the enclosure. The dehumidifier system may comprise the fan system, as described above. Thus, air may be drawn and discharged using one or more fans of the fan system. The dehumidifier system may comprise a dehumidifier unit. The dehumidifier unit may be any suitable type of dehumidifier for working at the air temperature within the enclosure. An example of a dehumidifier for working at temperatures below 0° C. is a desiccant dehumidifier. Desiccant dehumidifiers typically operate by passing a humid process air stream through a desiccant material (for example, a silica gel) which absorbs moisture from the process air stream passing through it. To regenerate the desiccant material (i.e., remove the absorbed moisture), a regeneration air stream is heated and passed through the desiccant material such that the absorbed moisture is drawn into the regeneration air stream and then vented, e.g. to the outside of the enclosure. To allow the desiccant dehumidifier to operate continuously, the desiccant material may be contained in a rotating wheel such that a portion of the wheel is passed through the process air stream and another portion of the wheel is passed through the regeneration air stream. In the case where the dehumidifier unit is a desiccant dehumidifier, the regeneration air stream may originate from warmer areas of the storage and retrieval system, for example, using the air outside the enclosure which may or may not have been heated, to improve energy efficiency.

To dehumidify the air within the enclosure, the dehumidifier system may comprise a control system comprising a humidity sensor for measuring relative humidity (e.g. a capacitive or resistive humidity sensor) and a temperature sensor for measuring air temperature. The control system may further comprise a controller to calculate the dew point based on these measurements using known equations that relate dew point, relative humidity and temperature, e.g., the Magnus formula or the Arden Buck equation. The controller can then control the operation of the dehumidifier unit (i.e. control parameters of the dehumidifier unit to increase or decrease moisture absorption) to maintain the dew point of the discharged air at a particular set point. The control system could alternatively be configured to control the operation of the dehumidifier unit to maintain the relative humidity of the discharged air at a particular set point that will result in a dew point that is lower than the control temperature of the first air temperature (based on calculations performed ahead of time).

The dehumidifier air flow rate is preferably high enough to create a positive pressure in the enclosure relative to the outside the enclosure to substantially prevent air flowing from outside the enclosure to the inside the enclosure via the ducting. The air flow rate that is required can be determined by calculating the theoretical rate at which air will flow from outside the enclosure to the inside the enclosure via the ducting due to the temperature differential between first air temperature and the second air temperature.

To provide a high enough air flow rate and/or to provide redundancy in the case of dehumidifier unit failure, the dehumidifier system can comprise a plurality of dehumidifier units configured to draw air from the outside the enclosure, dehumidify the drawn air and discharge the dehumidified air into the enclosure.

In some embodiments and examples, the storage and retrieval system may further comprise at least one load handling device comprising: a driving assembly configured to move the load handling device on the track structure; a container-holding assembly configured to releasably hold a storage container from above; and a lifting assembly configured to raise and lower the container-holding assembly to allow the load handling device to lift and lower storage containers into and out of the storage columns and port columns via the grid cells.

The at least one load handling device operable on/with the track structure can therefore pick up a storage container from a stack of storage containers, using the lifting assembly, and move the picked storage container, using the drive assembly, to a drop-off column. Once the picked storage container is dropped into the drop-off column, the storage container will be conveyed by the conveying device of the access station along the passage from the drop-off column to the pick-up column. The same or a different load handling device may then pick the storage container from the pick-up column and return the storage container to a storage column within the supporting framework structure. In this way, storage containers can be moved to and from the access station for items to be picked from the storage containers.

### BRIEF DESCRIPTION OF THE DRAWINGS

The present invention will now be described, by way of example only, with reference to the accompanying drawings, in which:

FIG. 1A is a perspective view of a storage and retrieval system comprising an enclosure housing a storage structure and an access station.

FIG. 1B is a close-up view of the access station shown in FIG. 1A.

FIG. 2 is a schematic perspective view of a storage structure located within the first temperature zone with containers arranged within the storage structure and load handling devices on top of the storage structure.

FIG. 3 is a schematic plan view of a track structure on top of the storage structure.

FIG. 4 is a schematic perspective view of a load handling device with a container-holding assembly in a position below the bottom of the load handling device.

FIG. 5 is a schematic perspective view of the load handling device of FIG. 4 with a side portion of the external body omitted from view to show a container-receiving space.

FIG. 6 is a schematic perspective view of the load handling device of FIG. 5 with a container occupying the container-receiving space.

FIG. 7 is a schematic diagram of the storage and retrieval system with a temperature control system and a dehumidifier system.

FIG. 8 is a perspective view of a storage and retrieval system comprising a chamber enclosing the access station.

FIG. 9 is a schematic cross-sectional view of an access station comprising a solid barrier for selectively opening and closing an external opening of the access station.

FIG. 10 is a schematic cross-sectional view of an access station comprising an air curtain for blowing a stream of air across the external opening of the access station.

FIG. 11 is a perspective view of the storage and retrieval system of FIG. 1 with two access stations arranged in parallel.

FIG. 12 is a perspective view of the storage and retrieval system of FIG. 1 with two access stations arranged perpendicular to each other.

FIG. 13 is a perspective view of the storage and retrieval system of FIG. 1 with one access station arranged on one face of the storage structure.

In the figures, like features are denoted by like reference signs where appropriate.

### DETAILED DESCRIPTION

The following embodiments represent preferred examples of how the invention may be practised, but they are not necessarily the only examples of how this could be achieved. These examples are described in sufficient detail to enable those skilled in the art to practise the invention. Other examples may be utilised and structural changes may be made without departing from the scope of the invention as defined in the appended claims.

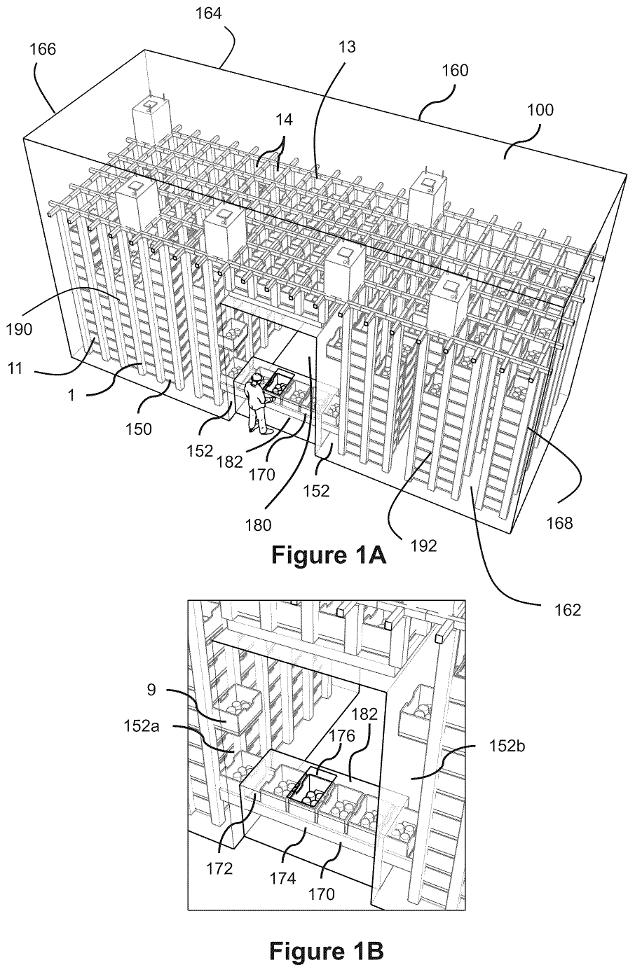

FIG. 1A shows a perspective view of a storage and retrieval system for storing and retrieving goods that are held in storage containers 9. The storage and retrieval system comprises an enclosure 160 which defines a first temperature zone 100 within the enclosure 160.

Housed within the enclosure 160 is a storage structure 1 for storing the storage containers 9. The storage structure 1 is therefore located within the first temperature zone 100. The enclosure 160 comprises walls which surround the storage structure 1 from the sides and from above. Specifically, the enclosure 160 comprises a front wall 162, a back wall 164 opposing the front wall 162 and a first side wall 166 and a second side wall 168 opposing the first side wall. The enclosure 160 may comprise closeable doors (not shown) for allowing access to and from the inside of the enclosure 160. The enclosure 160 may be located within a larger room of a building.

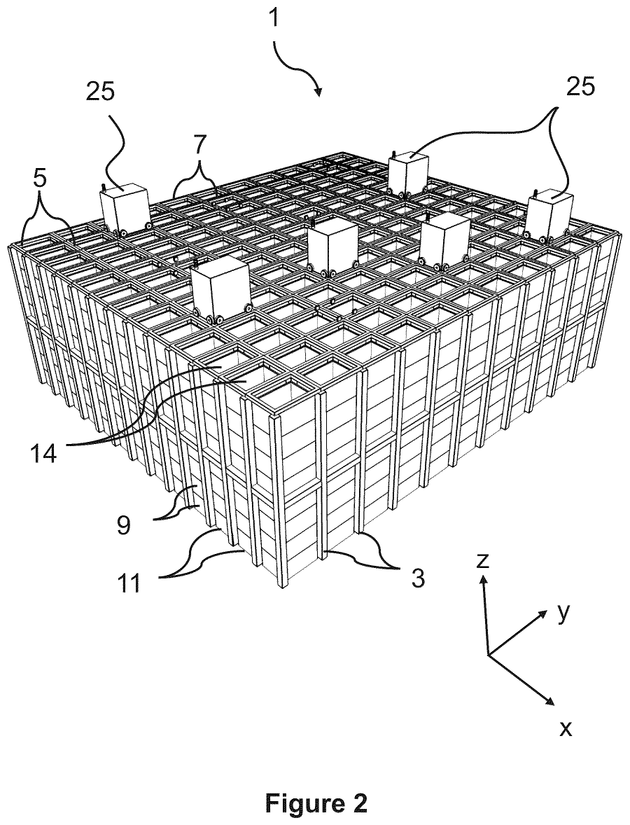

FIG. 2 shows an example storage structure 1 for storing storage containers 9 within the enclosure 160. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14.

Referring back to FIG. 1A, the storage structure 1 defines, below the grid cells 14, a plurality of storage columns 150 for storing stacks 11 of storage containers 9 and a plurality of port columns 152 through which storage containers 9 are transported to enter and/or leave the storage structure 1. Each storage column 150 and each port column 152 is located below a respective grid cell 14.

The enclosure 160 further houses an access station 170 which is located below the track structure 13 and is connected between two port columns 152a, 152b. The access station 170 and two port columns 152a, 152b are located closest to the front wall 162 of the enclosure 160 in FIGS. 1A and 1B. However it is also possible to have the access station 170 and two port columns 152a, 152b closest to the back wall 164 of the enclosure 160 or substantially centrally located between the front wall 162 and the back wall 164 of the enclosure. The access station 170 is positioned within a channel 180 extending from the front wall 162 to the back wall 164 of the enclosure 160. The channel 180 is arranged such that it divides the storage structure into two zones: a first zone 190 and a second zone 192. Stacks 11 of storage containers 9 are stored in the first zone 190 and the second zone 192, which are both at a first air temperature. The first zone 190 and the second zone 192 are linked or bridged by the track structure 13 and the access station 170.

FIG. 1B shows a close-up view of the access station 170. The purpose of the access station 170 is to receive storage containers 9 that have been retrieved from the storage structure 1 and present them to a human worker or a robotic arm located outside the enclosure 160 such that items can be moved into or out of the storage containers 9 from outside the enclosure 160. One example type of access station 170 is a picking station at which customer orders are prepared by picking ordered items out of storage containers 9 and placing them into a delivery receptacle such as a delivery container or a bag. Each access station 170 comprises a passage 172 extending between the two port columns 152a, 152b to form a continuous path for a storage container 9 to travel between the port columns 152a, 152b via the passage 172. In particular, one of the port columns 152a acts as a drop-off column 152a through which a storage container 9 retrieved from a storage column 150 is transported to the access station 170 and the other port column 152b acts as a pick-up column 152b through which a storage container 9 is transported away from the access station 170 for return to a storage column 150. In the context of a picking station, the drop-off column 152a may be used to drop-off a storage container 9 containing a product that has been ordered by a customer and the pick-up column 152b may be used to pick up the storage container 9 after the product has been taken out of the storage container 9.

The access station 170 further comprises a conveying device 174 for conveying a storage container 9 along the passage 172, from the drop-off column 152a to the pick-up column 152b. The conveying device 174 shown in FIG. 1 is in the form of a conveyor 174 (e.g. a roller conveyor or a belt conveyor) configured to move the storage container 9 in a substantially horizontal direction along the passage 172 but any other suitable device for conveying a storage container 9 between the port columns 152a, 152b could also be used. The conveyor 174 shown in FIG. 1 extends into the port columns 152a, 152b such that a storage container 9 can be lowered directly onto the conveyor 174 at the drop-off column 152a and picked up directly from the conveyor 174 at the pick-up column 152b. In other arrangements, a storage container 9 may be moved from a port column 152 onto the conveying device 174 or vice versa using another device, e.g. a pushing device.

The enclosure 160 comprises an external opening 176 to allow access to a storage container 9 in the passage 172 of the access station 170 from outside the enclosure 160. In this illustrated example, the external opening 176 is defined in a top-facing side of the enclosure 160. In other examples, the external opening 176 could be defined in other sides of the enclosure 160, e.g. a lateral side of the enclosure 160. During operation, the conveying device 174 is configured to pause movement of the storage container 9 at the external opening 176 to allow goods to be moved into or out of the storage container 9 through the external opening from outside the enclosure 160.

A portion of the enclosure 160 housing the access station 170 comprises a tunnel or passageway 182. The tunnel 182 extends between the two port columns 152, 152b such that the access station 170 is fully enclosed within the tunnel 182. The tunnel 182 comprises the external opening 176 for allowing access to a storage container at the access station 170 from outside the enclosure.

Referring back to FIG. 2, storage containers 9 are moved between the storage structure 1 and the access stations 170 using load handling devices 25, hereafter referred to as “bots”, which operate on top of the storage structure 1. In particular, the bots 25 are configured to move on tracks on top of the storage structure 1 and lift and lower storage containers through the grid cells 14.

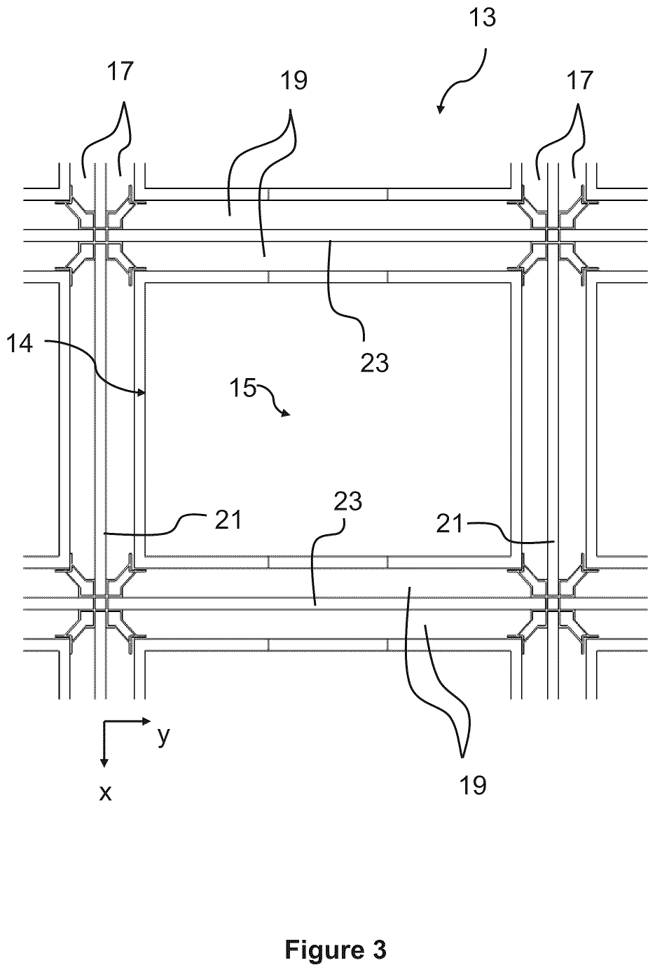

FIG. 3 shows a large-scale plan view of a section of track structure 13 forming part of the storage structure 1 illustrated in FIG. 1 and located on top of the horizontal members 5, 7 of the storage structure 1 illustrated in FIG. 2. The track structure 13 may be provided by the horizontal members 5, 7 themselves (e.g., formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow storage containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible. The bots 25 are provided with sets of wheels to engage with corresponding x-or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighbouring grid cells 14 without colliding with one another.

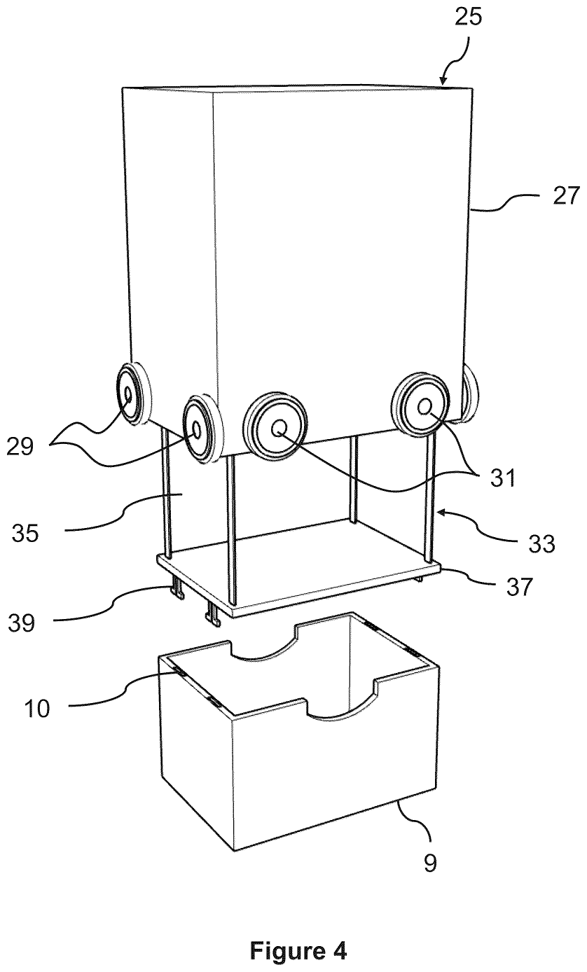

As illustrated in FIG. 4, a bot 25 comprises an external body 27 in or on which are mounted one or more components which enable the bot 25 to perform its intended functions. These functions may include moving across the storage structure 1 on the track structure 13 and raising or lowering storage containers 9 though the grid cells 14 so that the bot 25 can retrieve or deposit storage containers 9 in specific locations defined by the grid pattern.

The illustrated bot 25 comprises a driving assembly comprising first and second sets of wheels 29, 31 which are mounted on the external body 27 of the bot 25 and enable the bot 25 to move in the x-and y-directions along the tracks 17 and 19, respectively. In particular, two wheels 29 are provided on the shorter side of the bot 25 visible in FIG. 4, and a further two wheels 29 are provided on the opposite shorter side of the bot 25. The wheels 29 engage with tracks 17 and are rotatably mounted on the external body 27 of the bot 25 to allow the bot 25 to move along the tracks 17. Analogously, two wheels 31 are provided on the longer side of the bot 25 visible in FIG. 4, and a further two wheels 31 are provided on the opposite longer side of the bot 25. The wheels 31 engage with tracks 19 and are rotatably mounted on the external body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the external body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the external body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the external body 27 of the bot 25 stays substantially at the same height and therefore the weight of the external body 27 and the components mounted thereon does not need to be lifted and lowered by the wheel-positioning mechanism.

The bot 25 also comprises a lifting assembly 33 and a container-holding assembly 37 configured to raise and lower storage containers 9. The illustrated lifting assembly 33 comprises four tethers 35 which are connected at their lower ends to the container-holding assembly 37. The tethers 35 may be in the form of cables, ropes, tapes, or any other form of tether with the necessary physical properties to lift the storage containers 9. The container-holding assembly 37 comprises a gripping mechanism 39 configured to engage with features of the storage containers 9 to releasably hold the containers 9 from above. In the illustrated example, the gripping mechanism 39 comprises legs that can be received in corresponding apertures 10 in the rim of the storage container 9 and then moved outwards to engage with the underside of the rim of the storage container 9. The tethers 35 can be wound up or down to raise or lower the container-holding assembly 37 as required. One or more motors and winches or other means may be provided to effect or control the winding up or down of the tethers 35.

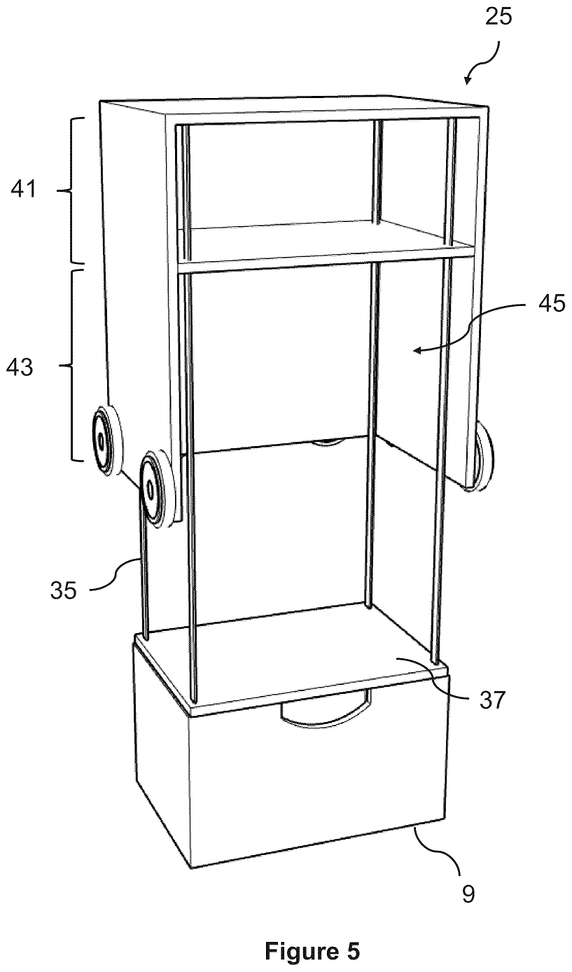

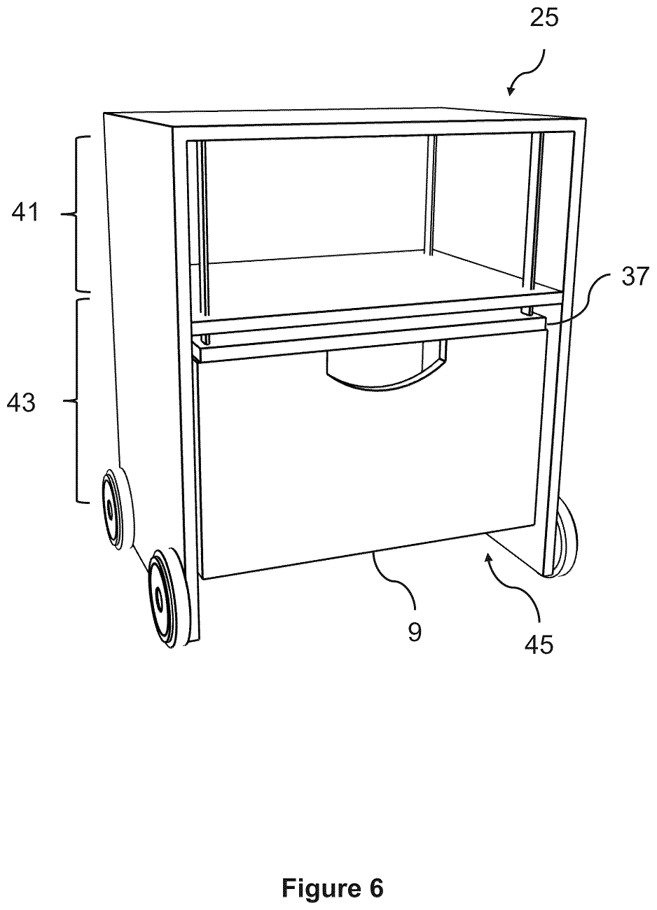

In FIG. 5 and FIG. 6, a side portion of the external body 27 of the bot 25 has been omitted from view to allow the interior of the bot 25 to be seen. The external body 27 of the illustrated bot 25 has an upper portion 41 and a lower portion 43. The upper portion 41 is configured to house or support one or more operation components (not shown), such as components of the lifting assembly 33 (e.g., motors), wireless communication components, a bot control system comprising one or more processors for controlling operation of the bot 25, etc. The lower portion 43 is arranged beneath the upper portion 41. The lower portion 43 is externally open at the bottom and defines a container-receiving space 45 for accommodating at least part of a storage container 9 that has been raised into the container-receiving space 45 by the lifting assembly 33. FIG. 5 shows the container-receiving space 45 before it is occupied by a storage container 9 and FIG. 6 shows the container-receiving space 45 after it has been occupied by a storage container 9. The container-receiving space 45 is sized such that enough of a storage container 9 can fit inside the space 45 to enable the bot 25 to move across the track structure 13 on top of storage structure 1 without the underside of the storage container 9 catching on the track structure 13 or another part of the storage structure 1. When the bot 25 has reached its intended destination, the lifting assembly 33 controls the tethers 35 to lower the container-holding assembly 37 and the corresponding storage container 9 out of the space 45 and into the intended position. Although in the illustrated example the upper and lower portions 41, 43 are separated by a physical divider, in other examples, the upper and lower portions 41, 43 may not be physically divided by a specific component or part of the external body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the external body 27 of the bot 25. For example, the container-receiving space 49 may instead be adjacent to the external body 27 of the bot 25, e.g. in a cantilever arrangement with the weight of the external body 27 of the bot 25 counterbalancing the weight of the container 9 to be lifted. In such embodiments, a frame or arms of the lifting assembly 33 may protrude horizontally from the external body 27 of the bot 25, and the tethers 35 may be arranged at respective locations on the protruding frame/arms and configured to be raised and lowered from those locations to raise and lower a storage container 9 into the container-receiving space 45 adjacent to the external body 27.

To transport a storage container 9 from a stack 11 in a storage column 150 to an access station 170, a bot 25 picks up a storage container 9 from the top of a stack 11 using its container-holding assembly 37 and lifting assembly 33, moves along the track structure 13 to a grid cell 14 above a drop-off column 152a, lowers the storage container 9 into the drop-off column 152a and releases the storage container 9 at the entrance to the access station 170 such that the conveying device 174 can move the storage container 9 along the passage 172 towards the pick-up column 152b.

Once the conveying device 174 has conveyed the storage container 9 from the drop-off column 152a to the pick-up column 152b (via a temporary stop at the external opening 176 as mentioned above), a bot 25 lowers its container-holding assembly 37 into the pick-up column 152b, picks up and lifts the storage container 9 into the container-receiving space 45 of the bot 25 and then moves along the track structure 13 to deposit the storage container 9 on top of a stack 11 in a storage column 150.

To minimise the time required for a bot 25 to spend raising or lowering storage containers 9 at a port column 152, one or more port columns 152 may comprise a container lift (not shown) configured to move vertically within at least a portion of the port column 152 to transport a storage container 9 between the access station 170 and a predetermined vertical position within the port column 152 at which the bot 25 can drop off or pick up a storage container 9.

In the storage and retrieval system described above, a storage container 9 can thus be retrieved from the storage structure 1, have goods moved into and/or out of the storage container 9 at the access station 170 and be returned back to the storage structure 1, without leaving the first temperature zone defined within the enclosure 160. This may be advantageous for the storage and retrieval of temperature-sensitive goods, such as grocery items. The present storage and retrieval system may be particularly advantageous for the storage and retrieval of frozen grocery items, which are typically stored at a temperature of −18° C. or lower for food safety reasons. In the case where human workers are used to move goods into and/or out of the storage containers 9 at the access stations 170, a human worker would typically be required to wear a significant level of personal protective equipment (PPE) and/or work in very short shifts to mitigate the effects of working at freezing temperatures. However, because the storage containers 9 of the present storage and retrieval system can remain in the enclosure 160 at all times while still being accessible from outside the enclosure 160 at the access station 170, the outside of the enclosure 160 can be warmer than the first temperature zone 100 inside the enclosure 160 to provide a more comfortable environment for the human workers to work in.

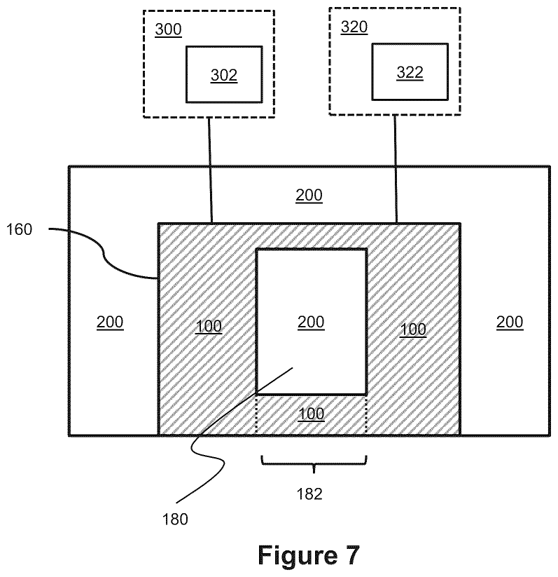

FIG. 7 is a schematic side-view diagram of the storage and retrieval system of FIG. 1 for the storage and retrieval of frozen goods. FIG. 7 shows the enclosure 160 comprising the tunnel 182 which houses the access station 170. The storage and retrieval system further comprises a temperature control system for regulating the air temperature in different areas of the system. To regulate the air temperature of the first temperature zone 100 inside the enclosure 160, the temperature control system comprises a refrigeration system 320 with one or more refrigeration units 322 having an appropriate control system and temperature sensors for maintaining the air temperature in the first temperature zone 100 at a control temperature (set point) suitable for freezing food items, e.g. below 0° C. For food safety, the control temperature of the first temperature zone 100 is preferably about −18° C. or lower, e.g. between −30° C. and −18° C.

The area outside the enclosure 160 may be considered a second temperature zone 200. To provide a more comfortable environment for human workers, the air temperature in the second temperature zone 200 is preferably maintained at a control temperature (set point) higher than the air temperature in the first temperature zone 100. To reduce heat transfer into the first temperature zone 100 from the second temperature zone 200 (and therefore reduce energy consumption of the refrigeration system 320 for the first temperature zone 100) while still providing increased comfort for human workers, the control temperature of the second temperature zone 200 is preferably between −10° C. and +10° C. To achieve this control temperature in the second temperature zone 200, the temperature control system may comprise a heating system or a refrigeration system as appropriate, depending on the natural room temperature of the second temperature zone 200 in the absence of any active temperature control in the second temperature zone 200.

To minimise heat transfer through the walls of the enclosure 160, the walls of the enclosure 160 are preferably formed from or comprise a thermally insulating material, e.g. foam insulation.

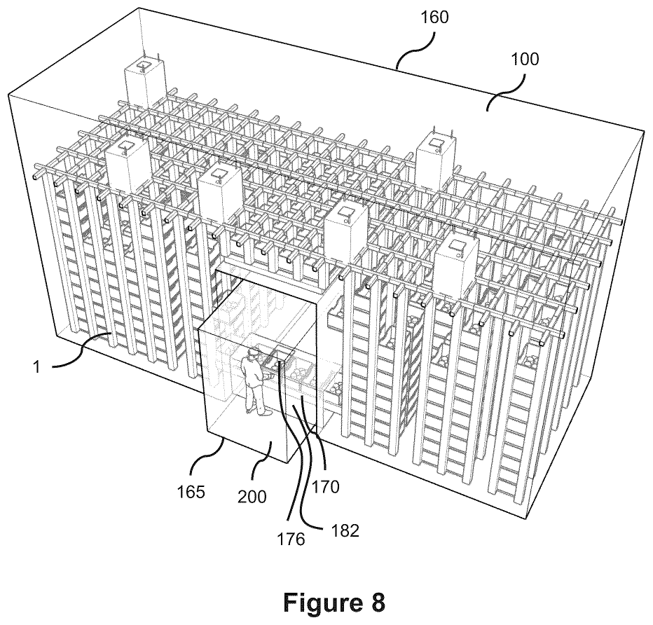

FIG. 8 shows the storage and retrieval system of FIG. 1 with the addition of a chamber 165 surrounding the access station 170 such that the external opening 176 is located within the chamber 165. In this example, the chamber 165 defines the temperature-controlled second temperature zone 200 referred to above and is sized to allow a human worker to enter the chamber 165 and work at the access station 170. A temperature-controlled chamber 165 surrounding the access station 170 may be advantageous in reducing energy costs compared to controlling the temperature of the whole area outside the enclosure 160. To minimise heat transfer through the walls of the chamber 165, the walls of the chamber 165 are preferably formed from or comprise a thermally insulating material, e.g. foam insulation. Specifically, the chamber 165 surrounds the tunnel 182 which houses the access station 170.

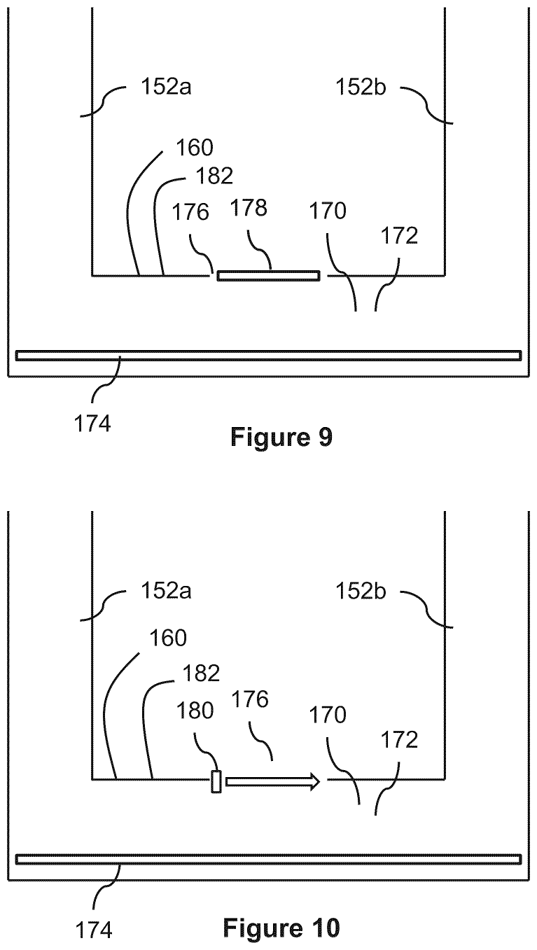

FIG. 9 shows a schematic cross-sectional view of one example of an access station 170 housed within the enclosure 160. To minimise the flow of warmer air from the second temperature zone 200 into the first temperature zone 100 via the external opening 176 in the enclosure 160, the enclosure 160, specifically the tunnel 182, preferably comprises a solid barrier 178 for selectively opening and closing the external opening 176. The barrier 178 may be a hinged barrier or a sliding barrier, for example. The enclosure 160, specifically the tunnel 182, further comprises a rotary or linear actuator as appropriate to move the barrier 178 to selectively open and close the external opening 176. The storage and retrieval system may comprise a control system configured to control the actuator to open the barrier 178 when a storage container 9 is at the external opening 176 and close the barrier 178 when a storage container 9 is not present at the external opening 176. The barrier 178 may be transparent to allow a human worker to see when the container 9 is at the external opening 176.

FIG. 10 shows a schematic cross-sectional view of a second example of an access station 170 housed within the enclosure 160. To minimise the flow of warmer air from the second temperature zone 200 into the first temperature zone 100 via the external opening 176 in the enclosure 160, this enclosure 160, specifically the tunnel 182, comprises an air curtain 180 configured to produce a continuous stream of air across the external opening 176. The stream of air acts as an air barrier which minimises air flow through the external opening 176 while still allowing goods to be passed through the external opening 176 relatively unimpeded.

In other examples, a barrier 178 may be provided in addition to an air curtain 180.

Alternatively or in addition to the barrier 178 and/or air curtain 180, the enclosure 160 may comprise a fan system comprising one or more fans configured to blow air from outside the enclosure 160 (e.g. the second temperature zone 200) into the enclosure 160 such that the air pressure inside the enclosure 160 is higher than the air pressure outside the enclosure 160 (in the vicinity of the external opening 176). This positive pressure inside the enclosure 160 acts to minimise airflow from the second temperature zone 200 into the first temperature zone 100.

To mitigate the risk of condensation and ice formation inside the enclosure 160 caused by moist air entering the enclosure 160 via the fan system, the fan system is preferably part of a dehumidifier system 300 comprising one or more dehumidifier units 302 configured to draw air from outside the enclosure 160, dehumidify (i.e. remove moisture from) the drawn air and discharge (blow) the dehumidified air into the enclosure 160 to generate the positive pressure.

The dehumidifier unit 302 is configured to dehumidify the air drawn from outside the enclosure 160 such that the dew point of the air being discharged into the enclosure 160 is lower than the control temperature of the first temperature zone 100. As a safety margin, the dew point of the discharged air is preferably at least two to three degrees Celsius lower than the control temperature of the first temperature zone 100. Given that the one or more refrigeration units 322 of the refrigeration system 320 may be outputting air that is slightly colder than the control temperature in the first temperature zone 100 to keep the air temperature at the set point, the dew point of the discharged air is preferably lower than the temperature of the air being output by the one or more refrigeration units 322 in order to minimise the risk of ice forming on and near the refrigeration units 322. Therefore, as a further safety margin, the dew point of the discharged air is preferably at least two to three degrees Celsius lower than the temperature of the air being output from the refrigeration unit 320. The temperature of the air being output from the refrigeration unit 322 could be measured with a temperature sensor, or a static expected value could be assumed.

To dehumidify the air drawn from outside the enclosure 160 to a particular dew point, the dehumidifier system 300 comprises a control system comprising a humidity sensor for measuring relative humidity (e.g. a capacitive or resistive humidity sensor) and a temperature sensor for measuring air temperature. The control system further comprises a controller to calculate the dew point based on these measurements using known equations that relate dew point, relative humidity and temperature, e.g. the Magnus formula or the Arden Buck equation. The controller can then control the operation of the dehumidifier unit 302 (i.e. control parameters of the dehumidifier unit 302 to increase or decrease moisture absorption) to maintain the dew point of the discharged air at a particular set point. The control system could alternatively be configured to control the operation of the dehumidifier unit 302 to maintain the relative humidity of the discharged air at a particular set point that will result in a dew point that is lower than the control temperature of the first temperature zone 100 (based on calculations performed ahead of time).

The dehumidifier unit 302 may be any suitable type of dehumidifier for working at low temperatures (e.g. below 0° C.), such as a desiccant dehumidifier. The dehumidifier system 300 or the dehumidifier unit 302 itself may further comprise a cooling unit for cooling the drawn air (before or after drying) such that the dried air being discharged into the enclosure 160 is at a similar temperature to the control temperature of the first temperature zone 100.

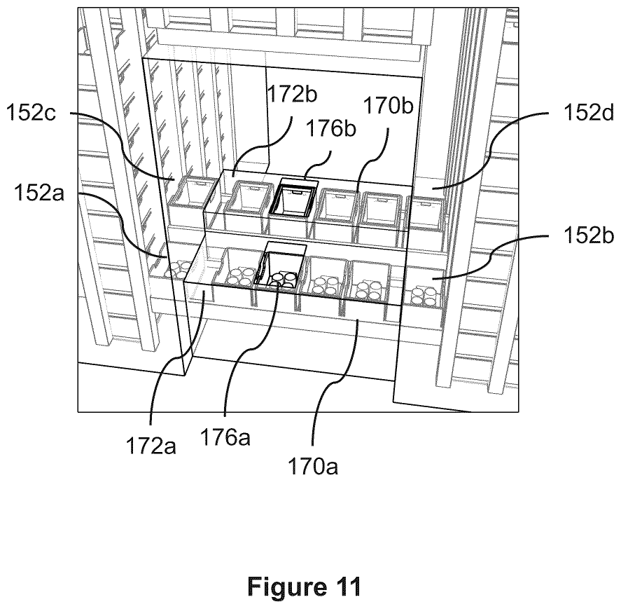

FIG. 11 shows an example of the storage and retrieval system in which the enclosure 160 houses a first access station 170a connected between a first drop-off column 152a and a first pick-up column 152b, and a second access station 170b connected between a second drop-off column 152c and a second pick-up column 152d. The first access station 170a and second access station 170b are located adjacent to each other and are arranged such that the passages 172a, 172b of the first and second access stations 170a, 170b extend parallel to each other between their respective drop-off columns and pick-up columns. In this illustrated example, the first access station 170a is used to pick inventory items out of storage containers 9 and the second access station 170b is used to present delivery containers into which the picked inventory items are placed. Alternatively, the first access station 170a could be used to present delivery containers in which the picked inventory items are placed and the second access station 170b could be used to pick inventory items out of storage containers 9. Since the delivery containers and the storage containers are substantially the same size and shape, the delivery containers can therefore be stored in and retrieved from the storage structure 1 in the same way as the storage containers 9 containing inventory items. As shown in FIG. 11, the first and second access stations 170a, 170b are arranged at different heights such that the external openings 176a, 176b providing access to the first and second access stations 170a, 170b are at different heights. This arrangement may be more ergonomic for a human worker when moving items from one access station to the other compared to an arrangement where the external openings providing access to the first and second access stations 170a, 170b are at approximately the same height.

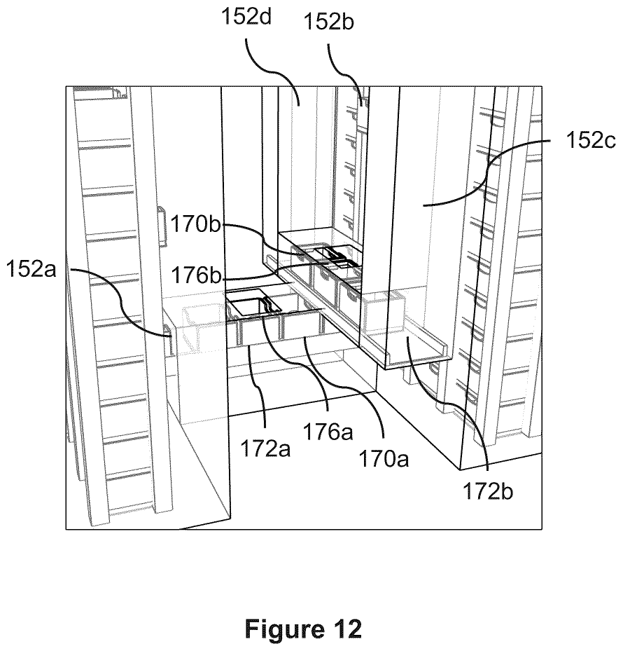

FIG. 12 shows another example also comprising a first access station 170a and a second access station 170b. In this example, the first access station 170a and second access station 170b are arranged such that the passage 172b of the second access station 170b extends over the passage 172a of the first access station 170a in a direction perpendicular to the passage 172a of the first access station 170a. This arrangement may also provide ergonomic benefits to a human worker when moving items from one access station to the other as the worker does not need to reach over one of the access stations to access the external opening 176 providing access to the other access station.

The chamber 165 described in relation to FIG. 8 can surround a plurality of access stations, e.g. the first and second access stations 170a, 170b of the examples described in relation to FIGS. 11 and 12.

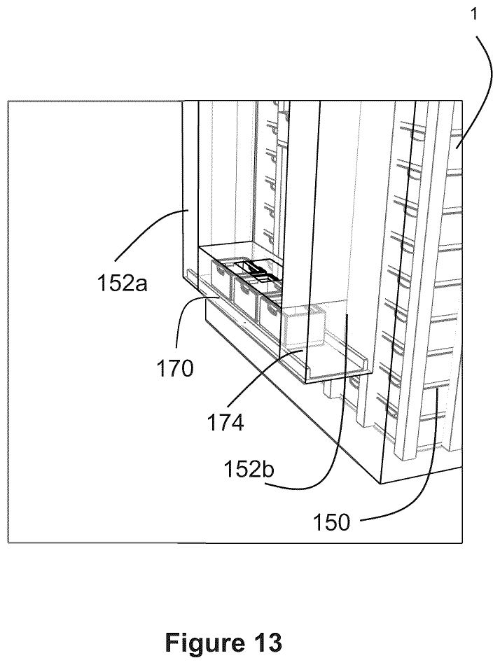

While the previous figures illustrate that the access station can be located within a channel 180, it is also possible for the access station to be located on the periphery of the storage structure, as shown in FIG. 13. Specifically, the access station is located on one face or side of the storage structure 1 and the passage 172 of the access station extends in a direction perpendicular to the height of the adjacent storage columns 150. The drop-off column 152a and the pick-up column 152b are also located on one face of the storage structure 1. The drop-off column 152a is positioned at the entrance to the access station 170, while the pick-up column 152b is positioned at the exit of the access station, as also illustrated in FIGS. 1 and 8 to 12. The track structure 13 extends across the storage structure 1 to allow a bot 25 to drop a container into a drop-off column 152a and pick up a container from a pick-up column 152b. As shown in FIG. 13, the access station 170, drop-off column 152a and pick-up column 152b are within the enclosure 1 such that they are kept at the first air temperature. By having an access station located on the periphery of the storage structure, there is no need for a channel, and thus the footprint of the storage and retrieval system is reduced. It is possible to have access stations 170 positioned on multiple faces of the storage structure 1, for example a first access station may be located on a first face of the storage structure and a second access station may be located on a second face of the storage structure, the second face being either opposite to or adjacent to the first face. Alternatively, a first access station and a second access station may both be located on the first face of the storage structure and may be positioned adjacent to each other.

It will be appreciated that the storage and retrieval system can be designed using various combinations of the arrangements described above. It will be appreciated that the features described herein may all be used together in a single system. In other embodiments of the invention, some of the features may be omitted. The features may be used in any compatible arrangement. Many variations and modifications not explicitly described above are possible without departing from the scope of the invention as defined in the appended claims.

What is claimed is:

1. A storage and retrieval system comprising:
an enclosure comprising a temperature control system configured to regulate the air temperature inside the enclosure, wherein the enclosure houses:
a storage structure comprising:
a supporting framework structure comprising a plurality of storage columns, each of the plurality of storage columns being arranged to accommodate a stack of storage containers;
a track structure comprising a plurality of tracks arranged to form a grid pattern defining a plurality of grid cells, said track structure is mounted on the supporting framework structure such that each stack of storage containers is arranged below a grid cell; and
a plurality of port columns comprising a drop-off column for dropping off a storage container from the track structure and a pick-up column for picking up a storage container from the track structure;
wherein a portion of the enclosure houses an access station located below the track structure, wherein the access station is between the drop-off column and the pick-up column to define a passage between the drop-off column and the pick-up column, the access station comprising a conveying device configured to convey a storage container along the passage; and
wherein the portion of the enclosure comprises an external opening for allowing access to a storage container at the access station from outside the enclosure.

2. The storage and retrieval system according to claim 1, wherein the temperature control system comprises a refrigeration system configured to maintain a first air temperature inside the enclosure.

3. The storage and retrieval system according to claim 2, wherein the first air temperature is at or below 0° C. (32° F.).

4. The storage and retrieval system according to claim 3, wherein the first air temperature is at or below −18° C. (0° F.).

5. The storage and retrieval system according to claim 2, wherein the temperature control system comprises a heating or refrigeration system configured to maintain a second air temperature outside the enclosure, wherein the second air temperature is higher than the first air temperature.

6. The storage and retrieval system according to claim 2, further comprising a second temperature control system, said second temperature control system comprises a heating or refrigeration system configured to maintain an environment externally of the enclosure having a second air temperature greater than the first air temperature.

7. The storage and retrieval system according to claim 6, further comprising a chamber surrounding the access station, said second temperature control system being configured to maintain the environment within the chamber at the second air temperature.

8. The storage and retrieval system according to claim 5, wherein the second air temperature is between −10° C. and 10° C.

9. The storage and retrieval system according to claim 8, wherein the air temperature outside the enclosure is between 0° C. and 10° C.

10. The storage and retrieval system according to claim 1, wherein the enclosure comprises a plurality of walls, wherein one or more walls is formed from or comprises a thermally insulating material.

11. The storage and retrieval system according to claim 1, wherein the portion of the enclosure comprises a barrier configured to selectively open and close the external opening.

12. The storage and retrieval system according to claim 1, wherein the portion of the enclosure comprises an air curtain configured to produce a stream of air across the external opening.

13. The storage and retrieval system according to claim 1, wherein the external opening is located on a top-facing side of the portion of the enclosure.

14. The storage and retrieval system according to claim 1, wherein the access station comprises a first access station and a second access station, the external opening comprising a first external opening and a second external opening such that the first external opening provides access to the first access station through the portion of the enclosure and the second external opening provides access to the second access station through the portion of the enclosure, and wherein the plurality of port columns comprises a plurality of drop-off columns and a plurality of pick-up columns, and the passage of the first access station and the second access station is connected between a respective drop-off column and a respective pick-up column.

15. The storage and retrieval system according to claim 14, wherein the first access station is below the second access station.

16. The storage and retrieval system according to claim 14, wherein the first access station is adjacent to a second access station; and wherein the passage of the first access station extends parallel to the passage of the second access station.

17. The storage and retrieval system according to claim 14, wherein the passage of the first access station extends under the passage of the second access station in a direction perpendicular to the passage of the second access station.

18. The storage and retrieval system according to claim 1, further comprising a fan system configured to generate a positive pressure within the enclosure.

19. The storage and retrieval system according to claim 1, further comprising a dehumidifier system configured to draw air from outside the enclosure, dehumidify the drawn air, and discharge the dehumidified air into the enclosure.

20. The storage and retrieval system according to claim 1, further comprising at least one load handling device comprising:
a driving assembly configured to move the load handling device on the track structure;
a container-holding assembly configured to releasably hold a storage container from above; and
a lifting assembly configured to raise and lower the container-holding assembly to allow the load handling device to lift and lower storage containers into and out of the storage columns and port columns via the grid cells.
